(19) United States
(12) Patent Application Publication
(10) Pub. No.: US 2007/0268795 A1
(43) Pub. Date: Nov. 22, 2007

(54) Optical disc signal processing apparatus, optical disc signal reproducing apparatus, signal processing circuit, and signal reproducing circuit

(76) Inventors: Takahiro Yamaguchi, Kyoto (JP); Takeshi Oda, Kyoto (JP)

Correspondence Address: MCDERMOTT WILL & EMERY LLP, 600 13TH STREET, NW, WASHINGTON, DC, 20005-3096, US

(21) Appl. No.: 11/802,305

(22) Filed: May 22, 2007

(30) Foreign Application Priority Data
May 22, 2006 (JP) 2006-141888

(51) Int. Cl. G11B 7/00

(52) U.S. Cl. 369/44.25; 369/53.2

(57) ABSTRACT

In a first reflected light amount comparing step and a first reflected light storing step, disc search is performed while moving a laser spot position from below to above an optical disc D, and a first reflected light amount which first becomes larger than or equal to a predetermined reflected light amount threshold is stored. Thereafter, in a second reflected light amount comparing step and a second reflected light storing step, disc search is performed while moving the laser spot position from above to below the optical disc D, and a second reflected light amount which first becomes larger than or equal to the predetermined reflected light amount threshold is stored. Thereafter, in a reflected light amount comparing step, the first and second reflected amounts are compared with each other. In a type determining step, it is determined whether or not the optical disc D is an SACD Hybrid, using the result of the comparison. Therefore, disc search can be performed while an optical disc is being rotated, and the type of the disc can be determined, without depending on a variation in performance of a circuit in a pickup.

### CROSS REFERENCE TO RELATED APPLICATIONS

This Non-provisional application claims priority under 35 U.S.C. §119(a) on Patent Application No. 2006-141888 filed in Japan on May 22, 2006, the entire contents of which are hereby incorporated by reference.

### BACKGROUND OF THE INVENTION

1. Field of the Invention

The present invention relates to an optical disc signal processing apparatus, an optical disc signal reproducing apparatus, a signal processing circuit, and a signal reproducing circuit for an optical disc having a plurality of data recording layers.

2. Description of the Related Art

In general, on optical discs, audio data or video data is recorded as digital data which is a sequence of “0” or “1” which is represented by a “pit”, and a large amount of data can be recorded by forming a sequence of pits in a spiral. Thus, optical discs are widely utilized as large-capacity recording media.

Optical disc signal processing apparatuses are used to reproduce data recorded on the optical disc. The optical disc signal processing apparatus comprises a pickup having a laser light source for emitting laser to an optical disc, an objective lens for forming a spot of the laser, a servo mechanism for adjusting the spot to become the smallest at a data recording layer of the optical disc, and a photodetector for collecting light reflected from the optical disc and detecting an amount of the reflected light. The optical disc signal processing apparatus receives laser reflected from the optical disc using the pickup to read and reproduce digital data recorded on the optical disc. The servo mechanism has a mechanism for moving the objective lens in a direction perpendicular to the data recording layer so that the laser spot is minimized at the data recording layer of the optical disc (the mechanism is hereinafter referred to as a focus servo).

As conventional optical discs, a CD (Compact Disc) and a DVD (Digital Versatile Disc) are widely known. The CD has a data recording layer formed at a distance of about 1.2 mm from a disc surface. Data recorded on the CD can be reproduced using laser having a wavelength of 780 nm and an objective lens having a numerical aperture of 0.45 (hereinafter referred to as a CD laser). The DVD has a data recording layer at a distance of about 0.6 mm from a disc surface. Data recorded on the DVD can be reproduced using laser having a wavelength of 650 nm and an objective lens having a numerical aperture of 0.6 (hereinafter referred to as a DVD laser). As another DVD, there is a double-layer DVD having two data recording layers. In the double-layer DVD, the two data recording layers are formed at a distance of about 0.6 mm from a disc surface, and the two data recording layers is separated by a distance of 55 μm.

In recent years, an SACD (Super Audio CD) which employs the 1-bit direct stream digital technology has been developed. The SACD has a high-density data recording layer called an HD layer which is located at a distance of about 0.6 mm from a disc surface. Data can be read from the SACD using the DVD laser. Data recorded in the HD layer is encrypted, so that a dedicated decoder LSI is required to reproduce the data.

As another SACD, an SACD Hybrid has been developed which has a data recording layer called a CD layer which can be reproduced by the CD laser in addition to the HD layer. The SACD Hybrid is a double-layer disc having two data recording layers (i.e., the HD layer and the CD layer). The HD layer (data recording layer) is formed at a distance of about 0.6 mm from a disc surface as in the SACD and the DVD, and the CD layer (data recording layer) is formed at a distance of about 1.2 mm from the disc surface as in the CD. The reflectance of the HD layer is standardized to be 80% or less of the reflectance of the CD layer.

In recent years, for SACD-supported optical disc signal processing apparatuses which can reproduce the CD, the DVD, and the SACD, it has become a significant problem how to correctly determine the type of a loaded optical disc when an SACD Hybrid is loaded into the optical disc signal processing apparatus.

Conventionally, there is a CD/DVD-supported optical disc signal processing apparatus which can determine whether the type of an optical disc is CD or DVD and reproduce data from the optical disc. Hereinafter, a method for determining the type of an optical disc by the CD/DVD-supported optical disc signal processing apparatus will be described.

Initially, in order to prevent laser from being emitted in the absence of an optical disc, it is detected based on a rotational acceleration whether or not an optical disc is loaded in the optical disc signal processing apparatus. The CD/DVD-supported optical disc signal processing apparatus comprises a pickup having a CD laser (hereinafter referred to as a CD pickup) and a pickup having a DVD laser (hereinafter referred to as a DVD pickup). In order to determine whether the loaded optical disc is a CD or a DVD, the CD pickup or the DVD pickup, which is vertically moved while irradiating the optical disc with laser, is used to collect reflected light obtained at a spot position with the photodetector and measure the amount of the reflected light. The step of irradiation with laser to the step of measuring the reflected light amount are collectively called “disc search”. Based on the reflected light amount obtained by the disc search, it is determined whether the loaded optical disc is a CD or a DVD. The disc search is generally performed while the loaded optical disc is being rotated, because the reflected light amount is measured by reading information of a pit sequence on the optical disc.

However, an SACD Hybrid is formed of two data recording layers (i.e., an HD layer and a CD layer) having different reflectances. Therefore, it is difficult to recognize an SACD Hybrid using a method similar to the optical disc determining method used in the CD/DVD-supported optical disc signal processing apparatus. Therefore, various optical disc determining methods supporting SACD Hybrids have been studied.

For example, Japanese Unexamined Patent Application Publication No. 2000-293932 describes a technique in which, based on the fact that the HD layer and the CD layer of an SACD Hybrid are formed at distances of 0.6 mm and 1.2 mm from the disc surface, respectively, the focus servo is vertically moved with a constant speed to perform disc search to measure times when spot positions appear at the data recording layers (i.e., the HD layer and the CD layer), and based on a difference between the times when the spot positions appear, it is determined whether or not a disc is an SACD Hybrid.

Japanese Unexamined Patent Application Publication No. 2004-288291 describes a technique in which the focus servo is vertically moved with a constant speed to perform disc search to measure drive values of the focus servo when spot positions appear at the data recording layers, and the focus drive values are used to determine whether or not a disc is an SACD Hybrid.

Japanese Unexamined Patent Application Publication No. 2004-146016 describes a technique in which, base on the fact that the CD layer dominantly reflects CD laser and the HD layer dominantly reflects DVD laser, the CD pickup and the DVD pickup are used to perform disc search, and when a predetermined reflected light amount or more is obtained in both the pickups, it is determined that a disc is an SACD Hybrid.

However, in an optical disc determining method employing the technique of Japanese Unexamined Patent Application Publication No. 2000-293932 above in which the difference between the times when the spot positions appear at the HD layer and the CD layer is used for determination, disc search cannot be performed while a disc is being rotated, for surface-wobbling discs in which a disc surface is moved up and down when the disc is rotated. Therefore, laser needs to be emitted before it is determined whether or not a disc is loaded, so that laser leaks outside. Also, since determination is based on the difference between times when spot positions of reflected light including surface reflection of a disc surface of a loaded optical disc appear, SACD Hybrids having a low surface reflectance are erroneously determined as a normal CD or DVD.

Also, in an optical disc determining method employing the technique of Japanese Unexamined Patent Application Publication No. 2004-288291 above in which determination is based on the drive values of the focus servo at spot positions at the data recording layers, since the focus servo drive value needs to be correctly obtained, disc search cannot be performed while a disc is being rotated, as is similar to the technique of Japanese Unexamined Patent Application Publication No. 2000-293932. Also, the focus servo drive value varies depending on the sensitivity of the focus servo or a variation in clamp position, so that a normal CD or DVD is erroneously determined as an SACD Hybrid.

Also, in an optical disc determining method employing the technique of Japanese Unexamined Patent Application Publication No. 2004-146016 above, assuming that there is a variation in the performance of the laser, photodetector, analog circuit or the like of the CD pickup or the DVD pickup, when the two pickups are used to determine the type of an optical disc, a normal CD or DVD is erroneously determined as an SACD Hybrid. Also, when data is read from an optical disc, such as an SACD Hybrid or the like, which has a plurality of data recording layers from which a predetermined reflected light amount or more is obtained, data is read and reproduced from a data recording layer different from a desired data recording layer.

### SUMMARY OF THE INVENTION

An object of the present invention is to enable disc search while an optical disc is being rotated and determination of the type of the optical disc irrespective of a variation in a semiconductor integrated circuit or the like constituting a pickup, thereby correctly reading and reproducing data from a desired data recording layer.

To achieve the object, the present invention provides an optical disc signal processing apparatus for an optical disc which has a plurality of data recording layers and a constant ratio between reflectances thereof. The optical disc signal processing apparatus employs a method for performing disc search using a single laser output circuit, storing reflected light amounts of predefined two of reflected light beams reflected from the optical disc, and based on the two reflected light amounts, determining the type of the optical disc or reproducing a desired data recording layer.

Specifically, an optical disc signal processing apparatus of the present invention comprises a laser output circuit for irradiating an optical disc with laser to detect a reflected light amount, wherein the optical disc has a plurality of data recording layers and a ratio between reflectances of the plurality of data recording layers is constant, a focus drive mechanism for moving the laser output circuit in a direction perpendicular to the optical disc to adjust a distance of a spot of the laser with respect to the optical disc, a first reflected light amount comparing circuit for comparing a measured reflected light amount with a predetermined reflected light amount threshold while using the focus drive mechanism to move a spot position of the laser from a position away from the optical disc to a closer position, a first reflected light amount storing circuit for storing a first reflected light amount which first becomes larger than or equal to the predetermined reflected light amount threshold in the first reflected light amount comparing circuit, a second reflected light amount comparing circuit for comparing a measured reflected light amount with the predetermined reflected light amount threshold while using the focus drive mechanism to move the laser spot position from a position close to the optical disc to a farther position, a second reflected light amount storing circuit for storing a second reflected light amount which first becomes larger than or equal to the predetermined reflected light amount threshold in the second reflected light amount comparing circuit, and a reflected light amount comparing circuit for comparing the first reflected light amount with the second reflected light amount.

In an embodiment of the optical disc signal processing apparatus of the present invention, a disc determining circuit is further provided for determining that the optical disc is a hybrid disc, based on the result of the comparison in the reflected light amount comparing circuit.

In an embodiment of the optical disc signal processing apparatus of the present invention, a surface reflection determining circuit is further provided for determining that the first reflected light amount is of surface reflection of the optical disc, based on the result of the comparison in the reflected light amount comparing circuit.

In an embodiment of the optical disc signal processing apparatus of the present invention, the predetermined reflected light amount threshold is increased in a stepwise manner.

An optical disc signal processing apparatus of the present invention comprises a laser output circuit for irradiating an optical disc with laser to detect a reflected light amount, the optical disc having a plurality of data recording layers and a ratio between reflectances of the plurality of data recording layers being constant, a focus drive mechanism for moving the laser output circuit in a direction perpendicular to the optical disc to adjust a distance of a spot of the laser with respect to the optical disc, a reflected light amount measuring circuit for measuring a plurality of reflected light amounts while using the focus drive mechanism to cause a spot position of the laser to move from a position away from the optical disc to a position at a predetermined distance or less from a disc surface, a largest reflected light amount storing circuit for storing a first reflected light amount which is the largest of a plurality of reflected light amounts obtained in the reflected light amount measuring circuit, and a second reflected light amount which is the largest after the first reflected light amount, and a reflected light amount comparing circuit for comparing the first reflected light amount with the second reflected light amount.

In an embodiment of the optical disc signal processing apparatus of the present invention, a disc determining circuit is further provided for determining that the optical disc is a hybrid disc, based on the result of the comparison in the reflected light amount comparing circuit.

An optical disc signal reproducing apparatus of the present invention employs the optical disc signal processing apparatus above. A reflected light amount reproduction threshold for determining a layer at which the focus drive mechanism is operated, is determined based on the first reflected light amount and the second reflected light amount. A reflected light amount is measured while moving a spot position of the laser from a position close to the optical disc to a farther position, and the measured reflected light amount is compared with the reflected light amount reproduction threshold. The focus drive mechanism is operated from a spot position where a reflected light amount larger than or equal to the reflected light amount reproduction threshold is first obtained.

A signal processing circuit of the present invention is provided for controlling a laser output circuit for irradiating an optical disc with laser to detect a reflected light amount, wherein the optical disc has a plurality of data recording layers and a ratio between reflectances of the plurality of data recording layers is constant, and a focus drive mechanism for moving the laser output circuit in a direction perpendicular to the optical disc to adjust a distance of a spot of the laser with respect to the optical disc. The signal processing circuit comprises a drive control section for controlling a drive direction of the focus drive mechanism, a reflected light amount receiving section for receiving the reflected light amount, a first reflected light amount comparing circuit for comparing the reflected light amount with a predetermined reflected light amount threshold based on the drive direction, a first reflected light amount storing circuit for storing a first reflected light amount which first becomes larger than or equal to the predetermined reflected light amount threshold in the first reflected light amount comparing circuit, a second reflected light amount comparing circuit for comparing the reflected light amount with the predetermined reflected light amount threshold based on a direction opposite to the drive direction, a second reflected light amount storing circuit for storing a second reflected light amount which first becomes larger than or equal to the predetermined reflected light amount threshold in the second reflected light amount comparing circuit, and a reflected light amount comparing circuit for comparing the first reflected light amount with the second reflected light amount.

In an embodiment of the signal processing apparatus of the present invention, a disc determining circuit is further provided for determining that the optical disc is a hybrid disc, based on the result of the comparison in the reflected light amount comparing circuit.

In an embodiment of the signal processing apparatus of the present invention, a surface reflection determining circuit is further provided for determining whether or not the first or second reflected light amount is of surface reflection of the optical disc, based on the result of the comparison in the reflected light amount comparing circuit.

In an embodiment of the signal processing apparatus of the present invention, the predetermined reflected light amount threshold is increased in a stepwise manner.

A signal processing circuit of the present invention is provided for controlling a laser output circuit for irradiating an optical disc with laser to detect a reflected light amount, wherein the optical disc has a plurality of data recording layers and a ratio between reflectances of the plurality of data recording layers is constant, and a focus drive mechanism for moving the laser output circuit in a direction perpendicular to the optical disc to adjust a distance of a spot of the laser with respect to the optical disc. The signal processing circuit comprises a drive control section for controlling a drive direction of the focus drive mechanism, a reflected light amount receiving section for receiving the reflected light amount, a reflected light amount storing circuit for storing a plurality of reflected light amounts received by the reflected light amount receiving section, a largest reflected light amount storing circuit for storing a first reflected light amount which is the largest of the plurality of reflected light amounts stored in the reflected light amount storing circuit and a second reflected light amount which is the largest after the first reflected light amount, and a reflected light amount comparing circuit for comparing the first reflected light amount with the second reflected light amount.

In an embodiment of the signal processing apparatus of the present invention, a disc determining circuit is further provided for determining that the optical disc is a hybrid disc, based on the result of the comparison in the reflected light amount comparing circuit.

A signal reproducing circuit of the present invention employs the signal processing circuit above. A reflected light amount reproduction threshold for determining a layer at which the focus drive mechanism is operated, is determined based on the first reflected light amount and the second reflected light amount. A reflected light amount is measured while moving a spot position of the laser from a position away from the optical disc to a closer position, and the measured reflected light amount is compared with the reflected light amount reproduction threshold. The focus drive mechanism is operated from a spot position where a reflected light amount larger than or equal to the reflected light amount reproduction threshold is first obtained.

Due to a variation in a semiconductor integrated circuit or the like included in optical disc signal processing apparatuses or the loaded state of an optical disc, there is a variation in a drive value or a time of a semiconductor integrated circuit when a reflected light of the optical disc is obtained. However, the reflected light amount of the optical disc is defined to have a predetermined value or more according to the standards. Therefore, according to the present invention, a reflected light amount measured while using the focus drive mechanism in the optical disc signal processing apparatus to raise a spot position of laser from below to above an optical disc, is compared with a predetermined reflected light amount threshold, and a first reflected light amount which first becomes larger than or equal to the predetermined reflected light amount threshold is stored. In addition, a reflected light amount measured while using the focus drive mechanism to lower the laser spot position from above to below the optical disc, is compared with the predetermined reflected light amount threshold, and a second reflected light amount which first becomes larger than or equal to the predetermined reflected light amount threshold is stored. Based on the two reflected light amounts (i.e., the first reflected light amount and the second reflected light amount), the type of the optical disc is determined. Therefore, an influence of a variation in a semiconductor integrated circuit or the like in the optical disc signal processing apparatus can be reduced.

Also, in the present invention, a plurality of reflected light amounts are measured while using the focus drive mechanism in the optical disc signal processing apparatus to raise a spot position of laser from a laser output circuit from below an optical disc to a position at a predetermined distance or more from a disc surface. Of the plurality of reflected light amounts, the largest reflected light amount (first reflected light amount) and a second reflected light amount which is the largest after the first reflected light amount are stored. Based on the two reflected light amounts (i.e., the first reflected light amount and the second reflected light amount), the type of the optical disc is determined. Therefore, two reflected light amounts can be obtained by a single disc search from below to above the optical disc, thereby making it possible to determine the type of the optical disc more quickly than when two disc searches are performed as described above.

Further, according to the present invention, a stable value of a reflected light amount of an optical disc can be obtained even for a surface-wobbling disc. Therefore, even when disc search is performed while rotating a surface-wobbling disc, an influence on determination of the type of the optical disc can be reduced. In addition, even when there is a variation in a semiconductor integrated circuit or the like included in a laser output circuit, since the first and second reflected light amounts are compared with the predetermined reflected light amount threshold, an influence of the variation in the semiconductor integrated circuit can be reduced by adjusting the predetermined reflected light amount threshold.

In addition, according to the present invention, since a layer at which the focus drive mechanism is operated is determined using the first and second reflected light amounts, thereby making it possible to cause the laser spot position to coincide with a position of a desired data recording layer.

### BRIEF DESCRIPTION OF THE DRAWINGS

FIG. 1 is a block diagram showing a whole configuration of an optical disc signal processing apparatus according to an embodiment of the present invention.

FIG. 2 is a block diagram showing a whole configuration of a laser pickup in the optical disc signal processing apparatus.

FIG. 3 is a block diagram showing a whole configuration of a control device in the optical disc signal processing apparatus.

FIGS. 4A to 4D are diagrams showing various optical discs. FIG. 4A is a cross-sectional view of a CD. FIG. 4B is a cross-sectional view of an SACD Hybrid. FIG. 4C is a cross-sectional view of a double-layer DVD. FIG. 4D is a cross-sectional view of a single-layer DVD.

FIG. 5 is a diagram showing a flow of an optical disc signal process in a first embodiment of the present invention.

FIGS. 6A to 6E are diagrams showing operations of the optical disc signal processing apparatus. FIG. 6A is a diagram showing drive values of a focus drive during disc search in the optical disc signal processing apparatus. FIG. 6B is a diagram showing laser spot positions of the optical disc signal processing apparatus. FIG. 6C is a diagram showing reflected light amounts of an SACD Hybrid. FIG. 6D shows reflected light amounts of a single-layer DVD. FIG. 6D′ is a diagram showing reflected light amounts of a double-layer DVD. FIG. 6E is a diagram showing reflected light amounts of a CD.

FIGS. 7A and 7B are diagrams showing an operation of the optical disc signal processing apparatus when a reflected light amount threshold is reset. FIG. 7A is a diagram showing drive values of the focus drive during disc search. FIG. 7B is a diagram showing reflected light amounts of a CD.

FIG. 8 is a diagram showing a flow of processing an optical disc signal according to a second embodiment of the present invention.

FIGS. 9A to 9C are diagrams showing an operation of the optical disc signal processing apparatus. FIG. 9A is a diagram showing drive values of the focus drive during disc search. FIG. 9B is a diagram showing reflected light amounts of an SACD Hybrid. FIG. 9C is a diagram showing reflected light amounts of a CD.

FIG. 10 is a schematic diagram showing a positional relationship between a data recording layer of a surface-wobbling disc and an objective lens of the optical disc signal processing apparatus.

FIGS. 11A to 11C are schematic diagrams showing reflected light amounts during disc search for the surface-wobbling disc of FIG. 10. FIG. 11A is a schematic diagram showing a positional relationship between the surface-wobbling disc and spot positions. FIG. 11B shows drive values of the focus drive during disc search. FIG. 11C shows reflected light amounts of an optical disc having only a single data recording layer.

FIGS. 12A to 12F are schematic diagrams showing a method for generating a focus error signal using astigmatism. FIG. 12A is a schematic diagram showing a photodetector of the optical disc signal processing apparatus. FIG. 12B is a diagram showing a shape of reflected light when a disc distance displacement amount is “0”. FIG. 12C is a diagram showing a shape of reflected light when the disc distance displacement amount has a “negative value”. FIG. 12D is a diagram showing a shape of reflected light when the disc distance displacement amount has a “positive value”. FIG. 12E is a diagram showing a relationship between disc distance displacement amounts and a focus error signal. FIG. 12F is a diagram showing a relationship between disc distance displacement amounts and reflected light amounts.

FIGS. 13A to 13C are diagrams showing an operation of an optical disc signal processing apparatus according to a conventional optical disc signal reproducing method. FIG. 13A is a diagram showing drive values of the focus drive. FIG. 13B is a diagram showing a focus error signal. FIG. 13C is a diagram showing reflected light amounts of a conventional optical disc, such as a CD or a DVD.

FIGS. 14A to 14C are diagrams showing an operation of an optical disc signal reproducing method according to an embodiment of the present invention. FIG. 14A is a diagram showing drive values of the focus drive. FIG. 14B is a diagram showing a focus error signal. FIG. 14C is a diagram showing reflected light amounts of an SACD Hybrid.

FIGS. 15A to 15C are diagrams showing an operation of an optical disc signal reproducing method according to another embodiment of the present invention. FIG. 15A is a diagram showing drive values of the focus drive. FIG. 15B is a diagram showing a focus error signal. FIG. 15C is a diagram showing reflected light amounts of an SACD Hybrid.

### DETAILED DESCRIPTION OF THE PREFERRED EMBODIMENTS

Hereinafter, preferred embodiments of the present invention will be described with reference to the accompanying drawings.

### First Embodiment

<<Whole Configuration of Optical Disc Signal Processing Apparatus>>

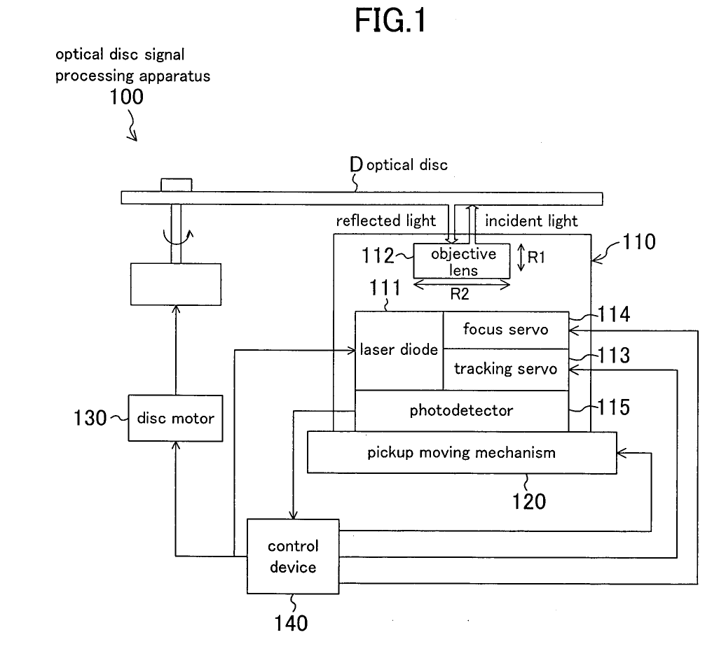

FIG. 1 is a block diagram showing a whole configuration of an optical disc signal processing apparatus according to an embodiment of the present invention.

In FIG. 1, the optical disc signal processing apparatus 100 comprises a laser pickup (laser output circuit) 110, a pickup moving mechanism 120, a disc motor 130, and a control device 140.

The laser pickup 110 comprises a laser diode 111 for emitting laser with which an optical disc D is irradiated, an objective lens 112 for forming a spot of the laser, a tracking servo 113 for performing tracking by adjusting a horizontal position (a direction R2 in FIG. 1) of the spot, a focus servo (focus drive mechanism) 114 for performing focusing by 25 adjusting a vertical position (a direction R1 in FIG. 1) of the spot, and a photodetector 115 for converting light reflected from the optical disc D into a light reception signal and transmitting the light reception signal to the control device 140. The optical disc D is irradiated with laser emitted from the laser diode 111 via the objective lens 112. Light reflected from the optical disc D is collected via the objective lens 112 onto the photodetector 115.

The pickup moving mechanism 120 is used to cause the main body of the laser pickup 110 to jump from track to track in a track direction of the optical disc D. The pickup moving mechanism 120 comprises a sled motor (not shown). The sled motor is controlled by the control device 140.

The tracking servo 113 and the focus servo 114 adjust a position of the objective lens 112 based on a control signal from the control device 140 so as to adjust the horizontal position and the vertical position of the laser spot. Operations of the tracking servo 113 and the focus servo 114 will be hereinafter described.

The tracking servo 113 and the focus servo 114 are each comprised of, for example, a coil fixed inside the pickup 110. The objective lens 112 is provided on, for example, a holder (not shown) which is attached to the main body of the pickup 110 in a manner which enables the holder to move. A magnet corresponding to the coil of each of the tracking servo 113 and the focus servo 114 is attached to the holder. Magnetic actions are generated between the coils and the magnets attached to the holder, depending on drive values of the tracking servo 113 and the focus servo 114. The action provides force which causes the holder to move, so that the horizontal or vertical position of the objective lens 112 is adjusted.

Here, the drive value of the tracking servo 113 is referred to as a tracking drive, and the drive value of the focus servo 114 is referred to as a focus drive. These drive values are each represented as a voltage value. The tracking drive and the focus drive are output and are supplied from the control device 140 to the tracking servo 113 and the focus servo 114.

Although only one laser pickup 110 is shown in FIG. 1, the optical disc signal processing apparatus of the embodiment of the present invention comprises two pickups, i.e., a CD pickup and a DVD pickup.

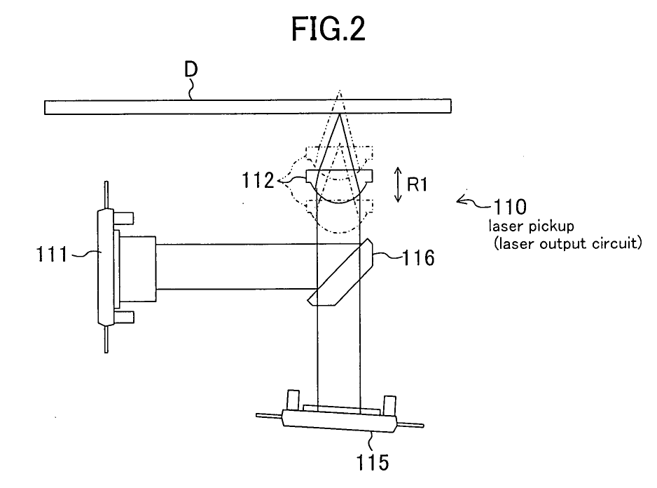

FIG. 2 is a block diagram showing a whole configuration of the laser pickup 110.

In FIG. 2, the direction of laser emitted from the laser diode 111 is changed by a half mirror 116, and the redirected laser is brought via the objective lens 112 to the optical disc D. By the laser being passed through the objective lens 112, a spot of the laser appears. Light reflected from the optical disc D is collected via the half mirror 116 onto the photodetector 115. The laser impinging on the optical disc D produces maximum reflected light when the spot is caused to coincide with a data recording layer of the optical disc D by adjusting the vertical position (the direction RI in FIG. 2) of the objective lens 112 using the focus servo 114.

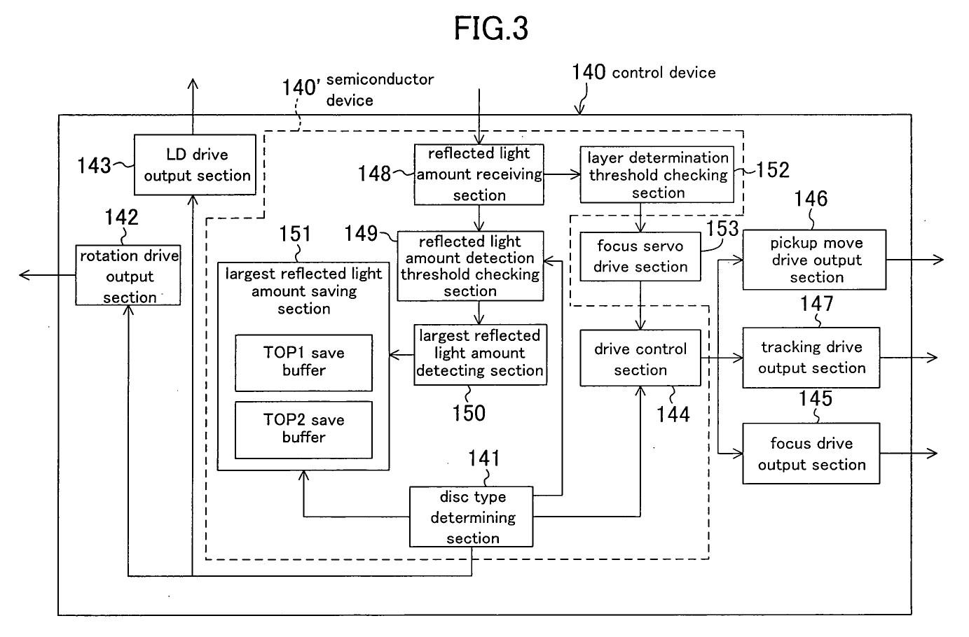

FIG. 3 is a block diagram showing a whole configuration of the control device 140. 140′ indicates a semiconductor device (a signal processing circuit, a signal reproducing circuit) included in the control device 140.

When the optical disc D is loaded into the optical disc signal processing apparatus 100, a disc type determining section 141 instructs a rotational drive output section 142 to rotate the disc motor 130. Thereby, the optical disc D is rotated. After the start of rotation of the disc motor 130, the disc type determining section 141 drives an LD drive output section 143 to operate and cause the laser diode 111 to emit laser.

Here, when the disc motor 130 is rotated in the absence of the optical disc D, the rotational speed of the disc motor 130 is faster than when the optical disc D is loaded. Therefore, by detecting the rotational acceleration of the disc motor 130, it is possible to detect whether or not the optical disc D is loaded, thereby preventing laser from being emitted in the absence of the optical disc D.

After the start of laser emission, the disc type determining section 141 instructs a drive control section 144 to perform disc search so that a focus drive output section 145 is operated to output a focus drive. The focus drive output from the focus drive output section 145 is supplied to the focus servo 114, so that the objective lens 112 is moved in the vertical direction, depending on the drive value of the focus drive. The drive control section 144 performs disc search until the spot of the laser emitted to the optical disc D comes to a position below or above the optical disc D. When the laser spot reaches a desired point, the focus drive output section 145 is instructed to stop the output of the focus drive.

The light reception signal output from the photodetector 115 is supplied to a reflected light amount receiving section 148. The reflected light amount receiving section 148 quantitatively detects a magnitude of the reflected light amount based on the light reception signal. A reflected light amount detection threshold checking section 149 determines whether or not the quantitatively detected reflected light amount is larger than a predetermined reflected light amount threshold. When the quantitatively detected reflected light amount is larger than the predetermined reflected light amount threshold, the reflected light amount is transmitted to a largest reflected light amount detecting section 150. The largest reflected light amount detecting section 150 determines whether or not the reflected light amount which is larger than or equal to the predetermined reflected light amount threshold is to be stored into a buffer. When it is determined that the reflected light amount is to be stored into the buffer, the reflected light amount is transmitted to a largest reflected light amount saving section 151. In the largest reflected light amount saving section 151, the reflected light amount is saved in a TOP1 save buffer and a TOP2 save buffer, and the reflected light amount stored in the two save buffers is held until the end of a control of the disc type determining section 141.

In the control device 140 of FIG. 3, the drive control section 144, the focus drive output section 145, the reflected light amount receiving section 148, the reflected light amount detection threshold checking section 149 are included in a first reflected light amount detecting circuit and a second reflected light amount detecting circuit, and perform a process of comparing a measured reflected light amount with a predetermined reflected light amount threshold while the position of the laser spot of the laser diode 111 is moved from below to above the optical disc D using the focus servo 114, and a process of comparing a measured reflected light amount with the predetermined reflected light amount threshold while the position of the laser spot of the laser diode 111 is moved from above to below the optical disc D using the focus servo 114.

Also, the largest reflected light amount detecting section 150 and the largest reflected light amount saving section 151 are included in a first reflected light amount storing circuit and a second reflected light amount storing circuit, and perform a process of storing into the TOP1 save buffer a first reflected light amount which first becomes larger than or equal to the predetermined reflected light amount threshold when the focus servo 114 is moved from below to above the optical disc D, and a process of storing into the TOP2 save buffer a second reflected light amount which first becomes larger than or equal to the predetermined reflected light amount threshold when the focus servo 114 is moved from above to below the optical disc D.

Further, the disc type determining section 141 is included in a reflected light amount comparing circuit, a type determining circuit, and a surface reflection determining circuit, and performs a process of comparing the first reflected light amount and the second reflected light amount obtained during disc search, and a process of determining the type of the optical disc D based on the result of the comparison (e.g., whether or not the optical disc D is an SACD Hybrid, and whether or not the first reflected light amount is of surface reflection). When the first reflected light amount is of surface reflection, a new threshold obtained by increasing the predetermined reflected light amount threshold in a stepwise manner is transmitted to the reflected light amount detection threshold checking section 149.

In addition, according to another embodiment, in the control device 140 of FIG. 3, the drive control section 144, the focus drive output section 145, the reflected light amount receiving section 148 are included in a reflected light amount measuring circuit, and perform a process of measuring a plurality of reflected light amounts while the spot position of the laser from the laser diode 111 is moved from below the optical disc D to a position at a predetermined distance or more (e.g., 1.2 mm or more) from the disc surface, using the focus servo 114.

Also, the largest reflected light amount detecting section 150 and the largest reflected light amount saving section 151 are included in a largest reflected light amount detecting circuit, and perform a process of storing a first reflected light amount which is the largest of a plurality of reflected light amounts obtained in the reflected light amount measuring circuit into the TOP1 save buffer, and storing a second reflected light amount which is the largest after the first reflected light amount into the TOP2 buffer.

Further, the disc type determining section 141 is included in a reflected light amount comparing circuit and a type determining circuit, and performs a process of comparing the first reflected light amount and the second reflected light amount obtained during disc search, and a process of determining the type of the optical disc D based on the result of the comparison (e.g., whether or not the optical disc D is an SACD Hybrid).

Note that, in FIG. 3, a pickup move drive output section 146 outputs a pickup move drive to a sled motor in the pickup moving mechanism 120 so as to cause the laser pickup 110 to jump from track to track in the track direction of the optical disc D. Also, a tracking drive output section 147 outputs a tracking drive to the tracking servo 113 so as to adjust the position of the objective lens 112 in the vertical direction.

<<Data Recording Layer in Optical Disc>>

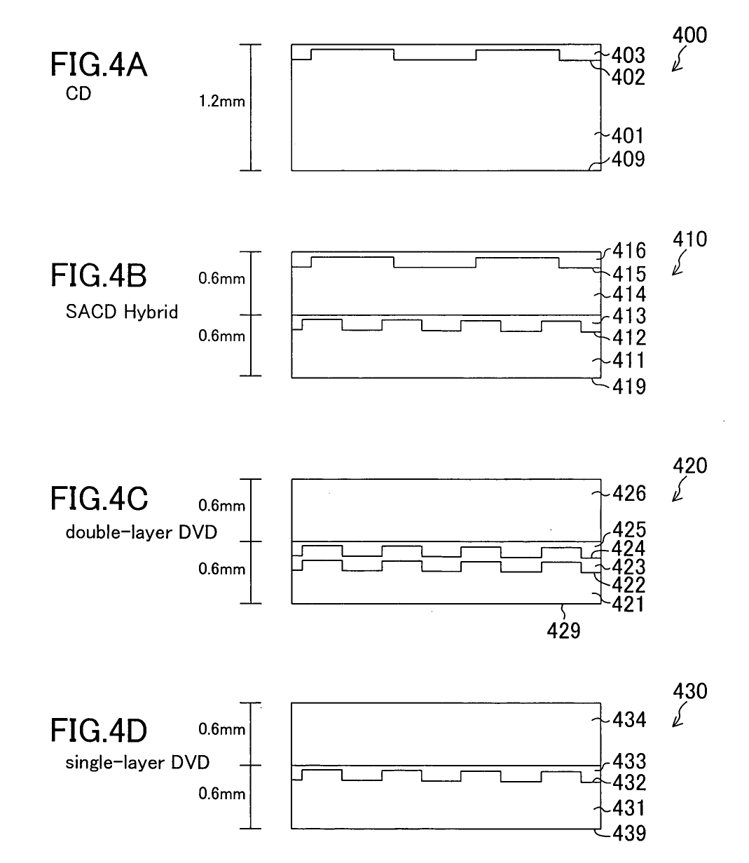

FIGS. 4A to 4D are cross-sectional views of an optical disc.

FIG. 4A shows a cross-sectional view of a CD, FIG. 4B shows a cross-sectional view of an SACD Hybrid, FIG. 4C shows a cross-sectional view of a double-layer DVD having two data recording layers, and FIG. 4D shows a cross-sectional view of a single-layer DVD having a single data recording layer.

In the CD 400 of FIG. 4A, a transparent layer 401 is formed of a transparent resin material, and a data recording layer 402 and a reflective layer 403 are formed at a distance of about 1.2 mm from a surface (a disc surface of the CD 400) 409 of the transparent layer 401.

In the SACD Hybrid 410 of FIG. 4B, an HD data recording layer 412 is formed at a distance of about 0.6 mm from a disc surface 419, and a CD data recording layer 415 is formed at a distance of about 1.2 mm from the disc surface 419. More specifically, the HD data recording layer 412 and a first reflective layer 413 are formed at a distance of about 0.6 mm from the disc surface 419 with a first transparent layer 411 being interposed between the HD data recording layer 412 and the first reflective layer 413, and the disc surface 419. The CD data recording layer 415 and a second reflective layer 416 are formed at a distance of about 0.6 mm above from the HD data recording layer 412 and the first reflective layer 413 with a second transparent layer 414 being interposed between the CD data recording layer 415 and a second reflective layer 416, and the HD data recording layer 412 and the first reflective layer 413. Here, according to the SACD Hybrid standards, a reflectance at the first reflective layer 413 is 15 to 30%, a reflectance at the second reflective layer 416 is 35% or more, and the reflectance at the first reflective layer 413 is 80% or less of the reflectance at the second reflective layer 416.

In the double-layer DVD 420 of FIG. 4C, a first data recording layer 422 and a second data recording layer 424 are formed at a distance of about 0.6 mm from a disc surface 429, and a dummy layer 426 having a thickness of 0.6 mm is attached on an upper portion of the first data recording layer 422 and the second data recording layer 424. More specifically, the first data recording layer 422 and a first reflective layer 423 are formed at a distance of about 0.6 mm from the disc surface 429 with a transparent layer 421 being interposed between the first data recording layer 422 and the first reflective layer 423, and the disc surface 429. The second data recording layer 424 and a second reflective layer 425 are attached on an upper portion of the first data recording layer 422 and the first reflective layer 423. Further, the dummy layer 426 having a thickness of 0.6 mm is attached to an upper portion of the second reflective layer 425. Here, according to the standards, an inter-layer distance between the first data recording layer 422 and the second data recording layer 424 is 55 μm, and reflectances at the reflective layers 423 and 425 are 18 to 30%.

In the single-layer DVD 430 of FIG. 4D, a data recording layer 432 and a reflective layer 433 are formed at a distance of about 0.6 mm from a disc surface 439 with a transparent layer 431 being interposed between the data recording layer 432 and the reflective layer 433, and the disc surface 439. A dummy layer 434 having a thickness of 0.6 mm is attached to an upper portion of the reflective layer 433. Here, according to the standards, a reflectance at the reflective layer 433 is 45 to 85%.

As described above, in the SACD Hybrid of FIG. 4B, the reflectances at the two data recording layers 412 and 415 are different from each other, the ratio of the reflectances is constant, and the two data recording layers 412 and 415 have shapes different from those of conventional optical discs, such as a CD, a DVD and the like. Therefore, by obtaining reflected light amounts at the reflective layers 413 and 416 on the respective data recording layers 412 and 415, it is possible to determine whether or not an optical disc is an SACD Hybrid.

Thus, according to this embodiment, a reflected light amount is measured in the vicinity of each of the data recording layers 412 and 415 while the spot position of laser emitted from the laser diode 111 is vertically moved by vertically moving the objective lens 112 in the laser pickup 110 so as to perform disk search, and based on the resultant reflected light amounts, the type of an optical disc is determined.

<<Optical Disc Signal Processing Method and Optical Disc Signal Processing Apparatus>>

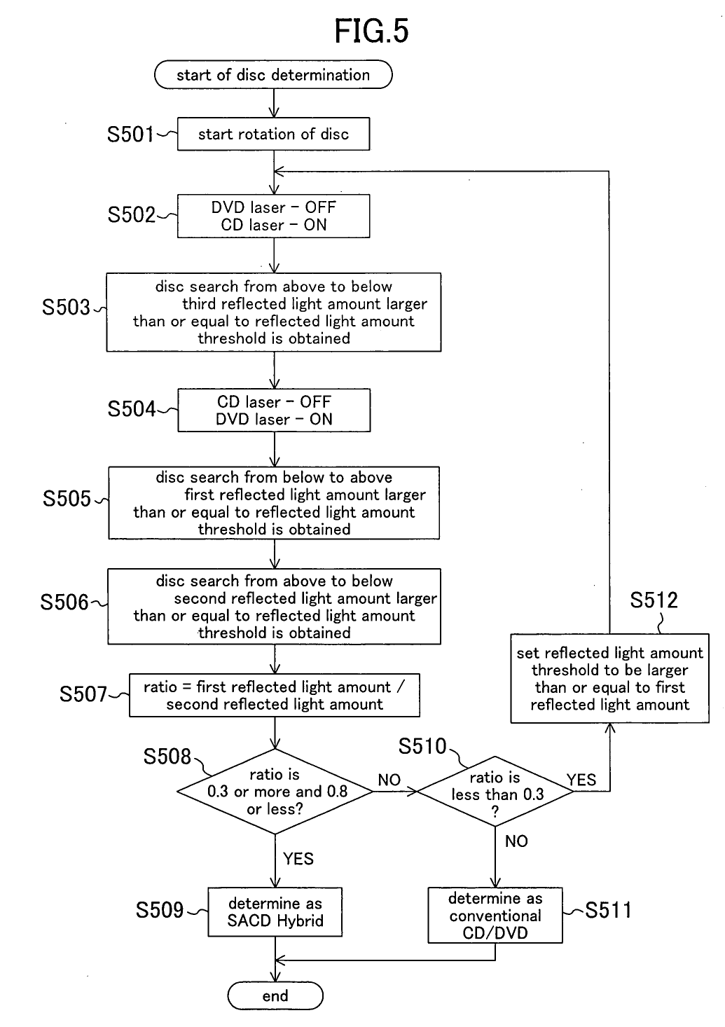

FIG. 5 is a diagram showing a flow of an optical disc signal process in the control device 140 of the first embodiment of the present invention.

When the optical disc D is loaded into the optical disc signal processing apparatus 100, the rotation of the disc motor 130 is started to rotate the optical disc D in step S501.

In step S502, the CD pickup is caused to emit CD laser. In step S503, the spot position of the CD laser is lowered from above to below the optical disc D so as to perform disk search, thereby obtaining a third reflected light amount which is larger than or more a predetermined reflected light amount threshold. The third reflected light amount thus measured is used in step S511 (described below) to determine whether the optical disc D is a CD or a DVD when it has been determined that the optical disc D is not an SACD Hybrid.

In step S504, the DVD pickup is caused to emit DVD laser. In step S505 (a first reflected light amount comparing step and a first reflected light amount storing step), the spot position of the DVD laser is raised from below to above the optical disc D so as to perform disk search, thereby obtaining a first reflected light amount which first becomes larger than or equal to the predetermined reflected light amount threshold, and the value of the first reflected light amount is stored into the TOP1 save buffer.

In step S506 (a second reflected light amount comparing step and a second reflected light amount storing step), the spot position of the DVD laser is lowered from above to below the optical disc D so as to perform disk search, thereby obtaining a second reflected light amount which first becomes larger than or equal to the predetermined reflected light amount threshold, and the value of the second reflected light amount is stored into the TOP2 save buffer.

In step S507 (a reflected light amount comparing step), the first reflected light amount obtained in step S505 is compared with the second reflected light amount obtained in step S506. Here, for example, the ratio α of the first and second reflected light amounts (e.g., α=the first reflected light amount/the second reflected light amount) is calculated.

In step S508 (a type determining step), the ratio α calculated in step S507 is used to determine whether or not the optical disc D is an SACD Hybrid. Here, considering that the reflectance of the HD layer is 80% or less of that of the CD layer according to the SACD Hybrid standards, and the first reflected light amount is of surface reflection of the optical disc D, when the ratio α is, for example, 0.3≦α≦0.8, it is determined that the loaded optical disc D is an SACD Hybrid (step S509).

When the ratio α is not 0.3≦α≦0.8, determination of step S510 is performed. In step S510 (a surface reflection determining step), it is determined whether or not the ratio α calculated in step S507 is α<0.3. When the ratio α is not α<0.3, it is determined in step S511 whether the optical disc D is a CD or a DVD, based on the first to third reflected light amounts. When the ratio α is α<0.3, it is determined that the first reflected light amount obtained in step S505 is of surface reflection, the predetermined reflected light amount threshold is increased from the first reflected light amount in a stepwise manner (step S512), and the optical disc signal process flow is executed again from step S502 in sequence. Note that, in step S512, the reflected light amount threshold is preferably reset and increased by a small amount from the first reflected light amount.

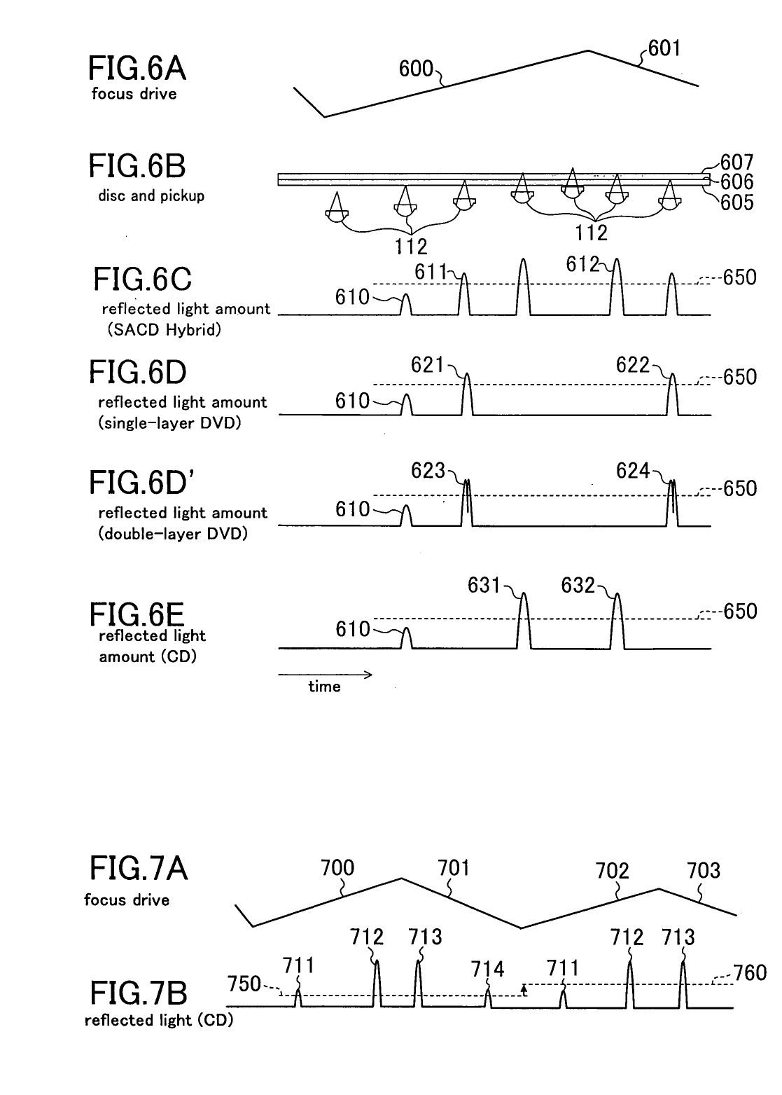

FIGS. 6A to 6E are diagrams showing operations of the optical disc signal processing apparatus of this embodiment. FIGS. 6A to 6E show operations of the optical disc signal processing apparatus in the first reflected light amount comparing step, the first reflected light amount storing step, the second reflected light amount comparing step, and the second reflected light amount storing step of the optical disc signal processing method.

FIG. 6A shows drive values of the focus drive during disc search. In 600, the drive value is increased to raise the objective lens 112 so as to raise the laser spot position. In 601, the drive value is decreased to lower the objective lens 112 so as to lower the laser spot position.

FIG. 6B shows laser spot positions corresponding to drive values of the focus drive of FIG. 6A. 605 indicates a disc surface of an SACD Hybrid (a disc surface of an optical disc), 606 indicates the HD layer (a data recording layer) of the SACD Hybrid (at a distance of 0.6 mm from the disc surface 605), 607 indicates the CD layer (a data recording layer) of the SACD Hybrid (at a distance of 1.2 mm from the disc surface 605).

FIGS. 6C to 6E show reflected light amounts of various optical discs. When the laser spot is positioned at the disc surface 605, a reflected light amount 610 is detected, independently of the optical disc type.

FIG. 6C shows reflected light amounts of an SACD Hybrid. The first reflected light amount comparing step corresponds to 600 in which the laser spot is moved from below to above the optical disc so as to perform disk search, i.e., the objective lens 112 is raised. Initially, when the laser spot is positioned at the disc surface 605, the reflected light amount 610 is obtained. The reflected light amount 610 is ignored because it is smaller than a predetermined reflected light amount threshold 650. When the laser spot is positioned at the data recording layer (HD layer) 606, a first reflected light amount 611 which is larger than or equal to the predetermined reflected light amount threshold 650 is detected. In the first reflected light amount storing step, the first reflected light amount 611 is stored into a save buffer. After the first reflected light amount 611 is saved, the spot position is moved to above the optical disc.

The second reflected light amount comparing step corresponds to 601 in which the laser spot is moved from above to below the optical disc so as to perform disk search, i.e., the objective lens 112 is lowered. When the laser spot is positioned at the data recording layer (CD layer) 607, a second reflected light amount 612 which is larger than or equal to the predetermined reflected light amount threshold 650 is detected. In the second reflected light amount storing step, the second reflected light amount 612 is stored into a save buffer. After the second reflected light amount 612 is saved, the spot position is moved to below the optical disc.

FIG. 6D shows reflected light amounts of a single-layer DVD. In the first reflected light amount comparing step and the first reflected light amount storing step, a first reflected light amount 621 which is larger than or equal to the predetermined reflected light amount threshold 650 is saved. In the second reflected light amount comparing step and the second reflected light amount storing step, a second reflected light amount 622 which is larger than or equal to the predetermined reflected light amount threshold 650 is saved.

FIG. 6D shows reflected light amounts of a double-layer DVD. In double-layer DVDs, the inter-layer distance between the two data recording layers is 55 μm, which is well smaller than the inter-layer distance (0.6 mm) of SACD Hybrids. Therefore, double-layer DVDs can be processed in a manner similar to that of single-layer DVDs. Specifically, in the first reflected light amount comparing step and the first reflected light amount storing step, a first reflected light amount 623 which is larger than or equal to the predetermined reflected light amount threshold 650 is saved. In the second reflected light amount comparing step and the second reflected light amount storing step, a second reflected light amount 624 which is larger than or equal to the predetermined reflected light amount threshold 650 is saved.

FIG. 6E shows reflected light amounts of a CD. In the first reflected light amount comparing step and the first reflected light amount storing step, a first reflected light amount 631 which is larger than or equal to the predetermined reflected light amount threshold 650 is saved. In the second reflected light amount comparing step and the second reflected light amount storing step, a second reflected light amount 632 which is larger than or equal to the predetermined reflected light amount threshold 650 is saved.

FIGS. 6A to 6E show the operations of the optical disc signal processing apparatus when the reflected light amount 610 at the disc surface 605 is smaller than or equal to the predetermined reflected light amount threshold 650. The reflected light amount 610 at the disc surface 605 is not constant due to a variation between optical discs or circuits of optical disc signal processing apparatuses. Therefore, in the surface reflection determining step, it is determined whether or not the first reflected light amount is a reflected light amount at the disc surface, and when it is determined that the first reflected light amount is a reflected light amount at the disc surface, the predetermined reflected light amount threshold is reset.

FIGS. 7A and 7B are diagrams showing an operation of the optical disc signal processing apparatus of this embodiment when a method for resetting the reflected light amount threshold is performed.

FIG. 7A shows drive values of the focus drive during disc search. In 700 and 7002, the drive value is increased to raise the objective lens 112 so as to raise the laser spot position. In 701 and 703, the drive value is decreased to lower the objective lens 112 so as to lower the laser spot position.

FIG. 7B shows reflected light amounts of a CD. 712 and 713 show reflected light amounts at the data recording layer of the CD. 711 and 714 show reflected light amounts at the disc surface of the CD.

Initially, in the first reflected light amount comparing step and the first reflected light amount storing step, the first reflected light amount 711 which is larger than or equal to a predetermined reflected light amount threshold 750 is saved. In the second reflected light amount comparing step and the second reflected light amount storing step, the second reflected light amount 713 which is larger than or equal to the predetermined reflected light amount threshold 750 is saved. In the reflected light amount comparing step, the ratio α of the first reflected light amount 711 and the second reflected light amount 713 (the first reflected light amount 711/the second reflected light amount 713) is obtained. The reflected light amount 711 at the disc surface has a value well smaller than the reflected light amount 713 at the data recording layer. Therefore, if a threshold for the ratio α is set to be, for example, 0.3, it is determined in the surface reflection determining step that the first reflected light amount 711 is a reflected light amount at the disc surface.

Next, the predetermined reflected light amount 750 is reset to be a reflected light amount 760 which is slightly larger than the reflected light amount 711. Thereafter, the above-described disc search procedure is executed again.

In the first reflected light amount comparing step and the first reflected light amount storing step which are performed again, the first reflected light amount 712 which is larger than or equal to the reset predetermined reflected light amount threshold 760 is saved. In the second reflected light amount comparing step and the second reflected light amount storing step, the second reflected light amount 713 which is larger than or equal to the predetermined reflected light amount threshold 760 is saved. By resetting the reflected light amount threshold 750 to be the reflected light amount threshold 760, erroneous determination due to the surface reflection of an optical disc is prevented, thereby making it possible to reliably save a reflected light amount at a data recording layer and thereby correctly determine the type of the optical disc.

Here, the reflected light amount threshold after resetting is preferably increased by small amounts in a stepwise manner from the first reflected light amount which has been determined to be of surface reflection.

Although SACD Hybrid has been described in this embodiment, the present invention may be applied to any optical discs in which a ratio between reflectances of a plurality of data recording layers is constant.

### Second Embodiment

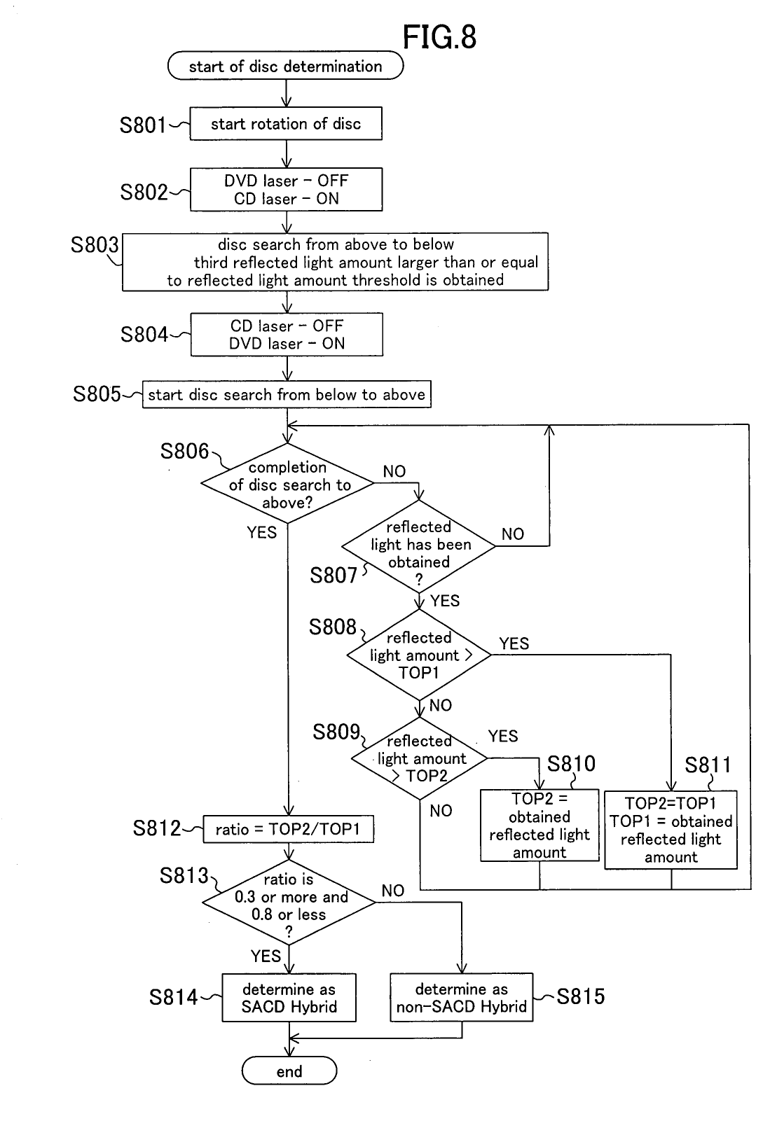

FIG. 8 is a diagram showing a flow of processing an optical disc signal according to a second embodiment in the control device 140. In the optical disc signal processing method of FIG. 8, assuming that disc search is performed from below to above the optical disc D, when two or more reflected light amounts are obtained, the largest reflected light amount TOP1 and the second largest reflected light amount TOP2 of the two or more reflected light amounts are stored, and it is determined whether or not the optical disc is an SACD Hybrid where the two reflected light amounts TOP1 and TOP2 are assumed to be first and second reflected light amounts.

When the optical disc D is loaded into the optical disc signal processing apparatus 100, rotation of the disc motor 130 is started to rotate the optical disc D in step S801.

In step S802, the CD pickup is caused to emit CD laser. In step S803, the spot position of the CD laser is lowered from above to below the optical disc D so as to perform disk search, thereby obtaining a third reflected light amount which is larger than or more a predetermined reflected light amount threshold. The third reflected light amount thus measured is used in step S815 (described below) to determine whether the optical disc D is a CD or a DVD.

In step S804, the DVD pickup is caused to emit DVD laser. In step S805, the spot position of the DVD laser is raised from below to above the optical disc D so as to start disc search. When a reflected light amount β is detected during the disc search, it is determined in step S808 whether or not the reflected light amount β is larger than a largest reflected light amount TOP1 which has been detected until that time. When the reflected light amount β is larger than the largest reflected light amount TOP1 (β>TOP1), the largest reflected light amount TOP1 is set to be the second largest reflected light amount TOP2 (TOP2=TOP1), and the largest reflected light amount TOP1 is replaced with the reflected light amount β (TOP1=β) in step S811.

When the reflected light amount β is smaller than the largest reflected light amount TOP1 and is larger than the second largest reflected light amount TOP2 (TOP2<β<TOP1), the second largest reflected light amount TOP2 is replaced with the reflected light amount β (TOP2=β) in step S810.

Steps S806 to S811 are included in a reflected light amount measuring step and a largest reflected light amount storing step. The above-described processes are repeatedly performed until it is determined in step S806 that the spot position of the DVD laser has reached at a predetermined distance of, for example, 1.2 mm or more from the disc surface of the optical disc D.

When it has been determined in step S806 that the laser spot position has reached at a distance of 1.2 mm or more above from the disc surface of the optical disc D, the largest reflected light amount TOP1 at that time is set as the first reflected light amount and the second largest reflected light amount TOP2 at that time is set as the second reflected light amount, and a ratio α of the first and second reflected light amounts (e.g., α=TOP2/TOP1) is calculated in step S812 (a reflected light amount comparing step).

Here, when the largest reflected light amount TOP1 or the second largest reflected light amount TOP2 has not been obtained, steps S805 to S812 are preferably executed again, for example.

Step S813 is included in a type determining step of determining whether or not the optical disc is an SACD Hybrid, using the ratio α calculated in step S812. Here, considering that the SACD Hybrid standards specify that the reflectance of the HD layer is 80% or less of the reflectance of the CD layer, and the first reflected light amount is of surface reflection of the optical disc D, when the ratio α is, for example, 0.3≦α≦0.8, the optical disc D is determined to be an SACD Hybrid in step S814.

When the ratio α is not 0.3≦α≦0.8, it is determined whether the optical disc D is a CD or a DVD, based on the first to third reflected light amounts, in step S813.

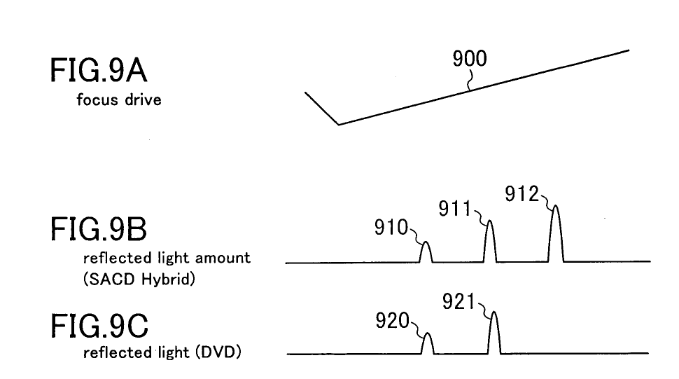

FIGS. 9A to 9C are diagrams showing an operation of the optical disc signal processing apparatus of another embodiment. FIG. 9 shows an operation of the optical disc signal processing apparatus in the reflected light amount measuring step and the largest reflected light amount storing step.

FIG. 9A shows drive values of the focus drive during disc search. In 900, the drive value is increased to raise the objective lens 112 so as to raise the laser spot position from below to above the optical disc D.

FIG. 9B shows reflected light amounts of an SACD Hybrid corresponding to the drive values of the focus drive of FIG. 9A.

In the period 900 in which disc search is performed from below the disc surface to above the optical disc, initially, a reflected light amount 910 at the disc surface is obtained Since the reflected light amount 910 is a reflected light amount which is first obtained during disc search, the largest reflected light amount TOP1 is the reflected light amount 910 (TOP1=the reflected light amount 910). When disc search is continued, a reflected light amount 911 at the HD layer (a data recording layer) is obtained. Since the reflected light amount 911 is larger than the reflected light amount 910 (TOP1) (i.e., the reflected light amount 911>the reflected light amount 910), the reflected light amount 910 is set as the second largest reflected light amount TOP2 (TOP2=the reflected light amount 910), and the reflected light amount 911 is set as the largest reflected light amount TOP1 (TOP1=the reflected light amount 911). When disc search is further continued, a reflected light amount 912 at the CD data recording layer which is larger than the reflected light amount 911 is obtained, the reflected light amount 911 is set as the second largest reflected light amount TOP2 (TOP2=the reflected light amount 911), and the reflected light amount 912 is set as the largest reflected light amount TOP1 (TOP1=the reflected light amount 912). Thereafter, the optical disc signal processing apparatus continues disc search until the laser spot position is located at a predetermined distance of 1.2 mm or more above from the disc surface.

Regarding reflected light amounts obtained during disc search, the largest reflected light amount TOP1 is the reflected light amount 912 at the CD data recording layer, and the second largest reflected light amount TOP2 is the reflected light amount 911 at the HD layer (data recording layer). Therefore, it is determined that the optical disc is an SACD Hybrid, based on the first reflected light amount 912 and the second reflected light amount 911.

FIG. 9C shows reflected light amounts of a single-layer DVD corresponding to the drive values of the focus drive of FIG. 9A.

When disc search is performed in a manner similar to FIG. 9B, the largest reflected light amount TOP1 is a reflected light amount 921 at the data recording layer, and the second largest reflected light amount TOP2 is a reflected light amount 920 at the disc surface. Based on the reflected light amounts 920 and 921, the optical disc is determined not to be an SACD Hybrid.

<<Disc Search for Surface-Wobbling Disc>>

Here, disc search for a surface-wobbling disc will be described.

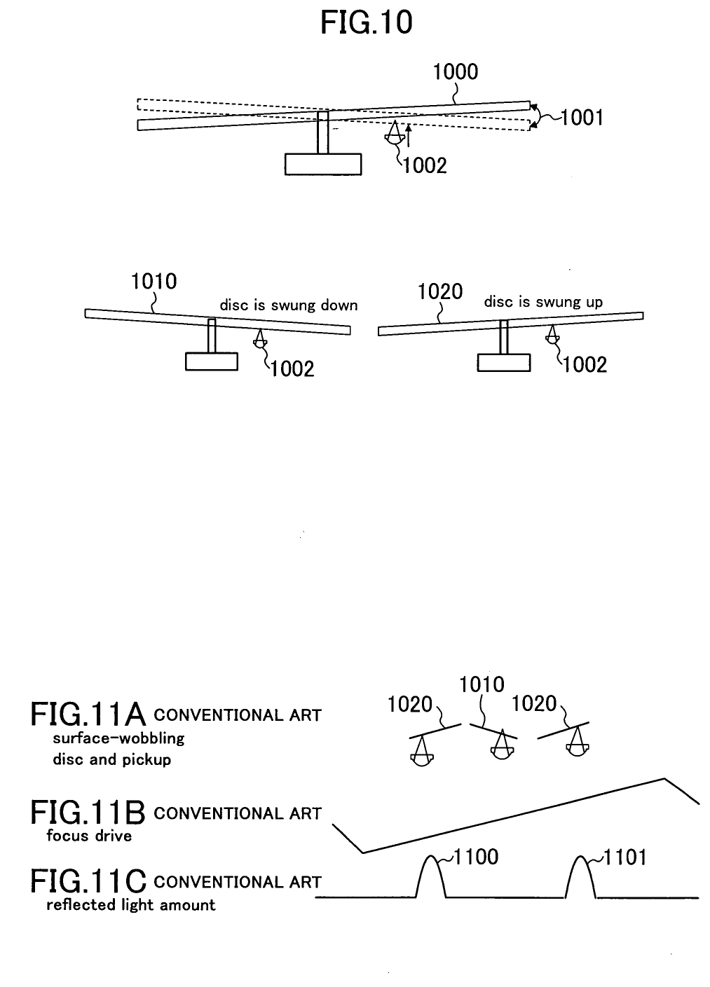

FIG. 10 is a schematic diagram showing a positional relationship between a data recording layer and an objective lens.

In FIG. 10, a surface-wobbling disc 1000 has a tilted axial direction. When the surface-wobbling disc 1000 is rotated, the surface-wobbling disc 1000 is moved up and down in the axial direction (indicated by 1001). During the up and down movement 1001, when an objective lens 1002 is moved up and down to perform disc search, the vertical position of a data recording layer differs between when the disc is swung down (indicated by 1010) and when the disc is swung up (indicated by 1020). Therefore, the focus position of the laser spot differs therebetween, so that the laser spot position with respect to a reflective layer on an upper portion of the data recording layer is not constant. Also, not only when the optical disc is rotated, but also when the optical disc is stopped, the laser spot position with respect to the reflective layer varies depending on a position where the optical disc is fixed.

FIGS. 11A to 11C are schematic diagrams showing reflected light amounts during disc search for the surface-wobbling disc of FIG. 10.

FIG. 11A is a schematic diagram showing a positional relationship between the surface-wobbling disc and spot positions, indicating disc search for an optical disc which has a single data recording layer, such as a conventional CD or DVD. FIG. 11B shows drive values of the focus drive. FIG. 11C shows reflected light amounts of the optical disc.

In conventional optical disc signal processing methods, when disc search is performed from below to above the optical disc, a reflected light amount 1100 is obtained when the surface-wobbling disc is swung up (1020). Thereafter, the surface-wobbling disc is swung down (1010). Thereafter, when the surface-wobbling disc is swung up again (1020), a reflected light amount 1101 is obtained. Thus, even in the case of an optical disc having a single data recording layer, a plurality of reflected light amounts may be obtained due to the up and down movement of the disc. In such a case, an optical disc which is not an SACD Hybrid may be erroneously determined as an SACD Hybrid.

In the optical disc signal processing method of the first embodiment, a first reflected light amount first obtained when disc search is performed from below to above an optical disc, and a second reflected light amount first obtained when disc search is performed from above to below the optical disc, are stored. Therefore, even when a plurality of reflected light amounts are obtained by performing disc search once, since a reflected light amount which first becomes larger than or equal to a predetermined reflected light amount threshold is stored. Therefore, even when an unexpected reflected light amount is obtained due to surface wobbling, the optical disc signal processing method of this embodiment is less affected than conventional methods.

Also, in the optical disc signal processing method of the second embodiment, a first reflected light amount which is the largest reflected light amount obtained when disc search is performed from below to above an optical disc, and a second reflected light amount which is the second largest reflected light amount, are used, whereby the optical disc signal processing method is similarly less affected by surface wobbling than conventional methods.

### Third Embodiment

<<Optical Disc Signal Reproducing Method and Optical Disc Signal Reproducing Apparatus>>

Hereinafter, an optical disc signal reproducing method according to an embodiment of the present invention will be described.

To reproduce data recorded in a data recording layer of the optical disc D, the optical disc signal processing apparatus 100 invariably converges the laser spot position to the data recording layer while maintaining constant the distance between the objective lens 112 and the data recording layer so as to cause the laser spot position to coincide with the data recording layer. Here, the optical disc signal processing apparatus 100 detects a distance between the spot position and the data recording layer of the optical disc D (hereinafter referred to as a disc distance displacement amount), and generates a focus error signal FE, depending on the disc distance displacement amount. Hereinafter, a method for detecting the focus error signal FE will be described.

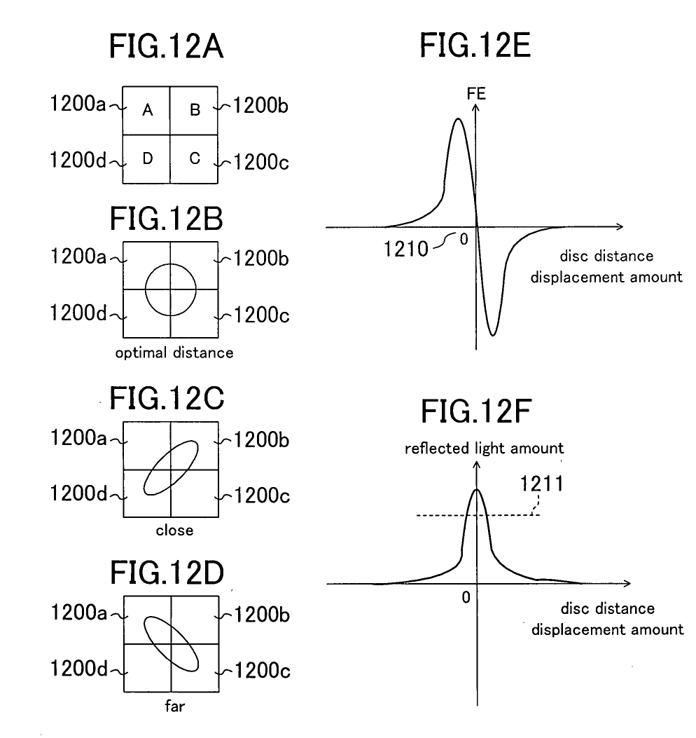

FIGS. 12A to 12F are schematic diagrams showing a method for generating the focus error signal FE using astigmatism.

FIG. 12A is a schematic diagram showing the photodetector 115 of the optical disc signal processing apparatus 100. The photodetector 115 comprises four light detecting elements 1200a to 1200d.

When the laser spot position coincides with the data recording layer of the optical disc D, i.e., the disc distance displacement amount is “0”, reflected light from the optical disc D forms substantially a perfect circle at a center of the photodetector 115 as shown in FIG. 12B.

When the laser spot position is focused above the data recording layer of the optical disc D, i.e., the disc distance displacement amount has a “negative value”, reflected light from the optical disc D forms an ellipse whose major axis is oriented in a direction from the light detecting elements 1200b to 1200d as shown in FIG. 12C.

When the laser spot position is focused below the data recording layer of the optical disc D, i.e., the disc distance displacement amount has a “positive value”, reflected light from the optical disc D forms an ellipse whose major axis is oriented in a direction from the light detecting elements 1200a to 1200c as shown in FIG. 12D.

Thus, the shape of reflected light formed on the photodetector 115 varies depending on the disc distance displacement amount. Therefore, when the focus error signal FE is obtained, a relationship between the disc distance displacement amount and the focus error signal FE shown in FIG. 12E is obtained by calculating “FE=(A+C)−(B+D)” where A to D represents reflected light amounts obtained by the light detecting elements 1200a to 1200d, respectively. Also, regarding the amount of reflected light from the optical disc D, a relationship between the disc distance displacement amount and the reflected light amount shown in FIG. 12F is obtained using “the reflected light amount=A+B+C+D” which is the sum of the reflected light amounts of all the light detecting elements 1200a to 1200d. Therefore, the position of the reflective layer of the optical disc D can be determined as a position 1210 where the reflected light amount is larger than or equal to a reflected light amount reproduction threshold 1211 and the focus error signal FE is “0”.

FIGS. 13A to 13C are diagrams showing an operation of an optical disc signal processing apparatus according to a conventional optical disc signal reproducing method.

FIG. 13A shows drive values of the focus drive. FIG. 13B shows the focus error signal FE. FIG. 13C shows reflected light amounts of a conventional optical disc, such as a CD or a DVD.

Initially, in the conventional optical disc signal reproducing method, disc search is performed from above to below the optical disc D so as to search for a spot position where the focus error signal FE is “0” and the reflected light amount is the largest, and a value smaller than the largest reflected light amount is set as the reflected light amount reproduction threshold 1211. Thereafter, disc search is performed from below to above the optical disc D so as to search for a reflective layer of the optical disc D. As described above, when the reflective layer is at the position 1210 where the reflected light amount is larger than or equal to the reflected light amount reproduction threshold 1211 and the focus error signal FE is “0”, it is determined that the laser spot position coincides with the reflective layer. Therefore, by starting an operation of the focus servo from that position, it is possible to read and reproduce data from the desired data recording layer.

A method for operating the focus servo at a desired data recording layer with respect to an optical disc having a constant ratio between reflectances of a plurality of data recording layers, such as an SACD Hybrid, in the optical disc signal reproducing method as described above will be hereinafter described.

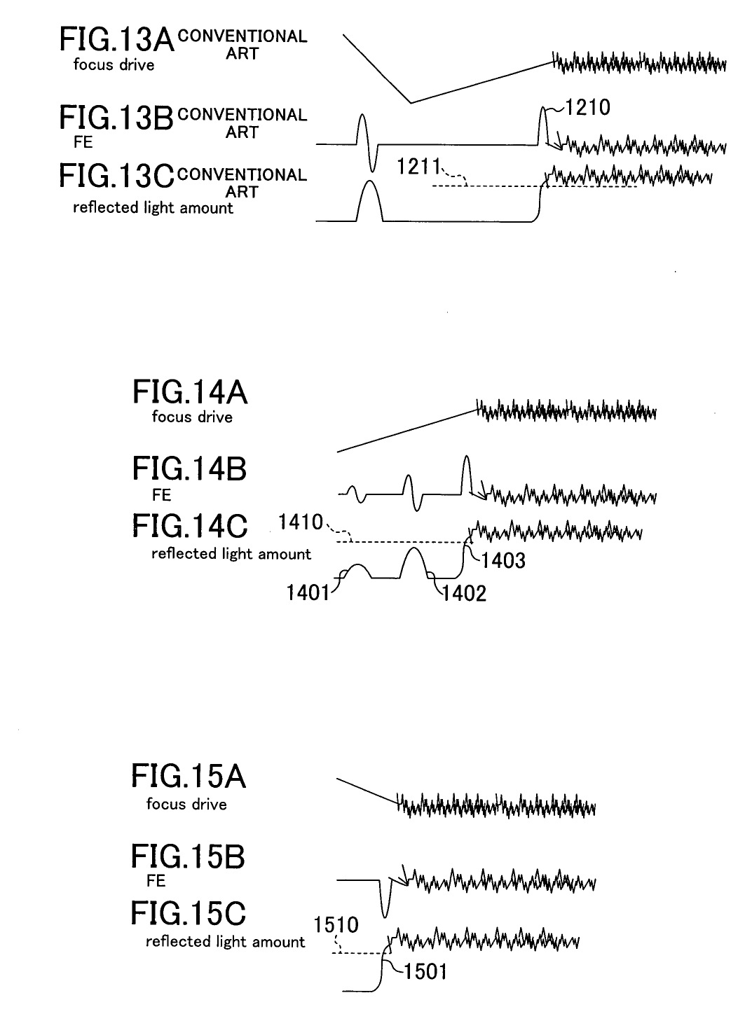

FIGS. 14A to 14C are diagrams showing an operation of an optical disc signal reproducing method according to an embodiment of the present invention.

FIG. 14A shows drive values of the focus drive. FIG. 14B shows the focus error signal FE. FIG. 14C shows reflected light amounts of an SACD Hybrid. Note that FIGS. 14A to 14C show an operation in which, when it is determined that an optical disc is an SACD Hybrid by the above-described optical disc signal processing method, the laser spot position is located below the optical disc D, and the focus servo is operated at the CD layer.

Initially, when it is determined that an optical disc is an SACD Hybrid, a reflected light amount at the HD layer and a reflected light amount at the CD layer have been specified. Here, for example, “(the reflected light amount at the HD layer+the reflected light amount at the CD layer)/2” is calculated to obtain a reflected light amount reproduction threshold 1410. Thereafter, disc search is performed from below to above the optical disc D. Here, a reflected light amount 1401 (a reflected light amount of surface reflection) and a reflected light amount 1402 (a reflected light amount at the HD layer) are measured, but the two reflected light amounts are smaller than or equal to the reflected light amount reproduction threshold 1410 and therefore are ignored. When disc search is continued, a reflected light amount 1403 (a reflected light amount at the CD layer) which is larger than or equal to the reflected light amount reproduction threshold 1410 is measured, and the focus servo is operated from this spot position. By operating the focus servo from the spot position where the reflected light amount 1403 is obtained, the focus servo can be correctly operated at the CD layer.

Note that the reflected light amount reproduction threshold 1410 may be calculated by other calculation expressions, and a smaller or larger reflected light amount reproduction threshold may be set.

An operation of the focus servo at the HD layer can be correctly started if a value slightly smaller than a reflected light amount at the HD layer is set as the reflected light amount reproduction threshold.

FIGS. 15A to 15C are diagrams showing an operation of an optical disc signal reproducing method according to another embodiment of the present invention.

FIG. 15A shows drive values of the focus drive. FIG. 15B shows the focus error signal FE. FIG. 15C shows reflected light amounts of an SACD Hybrid. Note that FIGS. 15A to 15C show an operation of the optical disc signal processing method in which the laser spot position is located above the optical disc D and the focus servo is operated at the CD layer when it has been determined that the optical disc D is an SACD Hybrid.

Initially, when it is determined that the optical disc D is an SACD Hybrid, a reflected light amount at the HD layer and a reflected light amount at the CD layer have been specified. A value slightly smaller than the reflected light amount at the CD layer is set as a reflected light amount reproduction threshold 1510. Thereafter, disc search is performed from above to below the optical disc D. Here, a reflected light amount 1501 which is larger than or equal to the reflected light amount reproduction threshold 1510 is measured, and a servo operation of the focus servo is started from a spot position where the focus error signal FE is “0”.

The optical disc signal reproducing method of FIGS. 15A to 15C is different from that of FIGS. 14A to 14C in that the focus servo can be started at the desired CD layer without useless disc search, thereby making it possible to reduce a time until the start of the operation of the focus servo and operate the focus servo at the CD layer more correctly.

Note that the optical disc signal reproducing method of FIGS. 14A to 14C is required so as to correctly operate the focus servo at the HD layer.

What is claimed is:

1. An optical disc signal processing apparatus comprising:
a laser output circuit for irradiating an optical disc with laser to detect a reflected light amount, wherein the optical disc has a plurality of data recording layers and a ratio between reflectances of the plurality of data recording layers is constant;
a focus drive mechanism for moving the laser output circuit in a direction perpendicular to the optical disc to adjust a distance of a spot of the laser with respect to the optical disc;
a first reflected light amount comparing circuit for comparing a measured reflected light amount with a predetermined reflected light amount threshold while using the focus drive mechanism to move a spot position of the laser from a position away from the optical disc to a closer position;
a first reflected light amount storing circuit for storing a first reflected light amount which first becomes larger than or equal to the predetermined reflected light amount threshold in the first reflected light amount comparing circuit;
a second reflected light amount comparing circuit for comparing a measured reflected light amount with the predetermined reflected light amount threshold while using the focus drive mechanism to move the laser spot position from a position close to the optical disc to a farther position;
a second reflected light amount storing circuit for storing a second reflected light amount which first becomes larger than or equal to the predetermined reflected light amount threshold in the second reflected light amount comparing circuit; and
a reflected light amount comparing circuit for comparing the first reflected light amount with the second reflected light amount.

2. The optical disc signal processing apparatus of claim 1, further comprising:
a disc determining circuit for determining that the optical disc is a hybrid disc, based on the result of the comparison in the reflected light amount comparing circuit.

3. The optical disc signal processing apparatus of claim 1, further comprising:
a surface reflection determining circuit for determining that the first reflected light amount is of surface reflection of the optical disc, based on the result of the comparison in the reflected light amount comparing circuit.

4. The optical disc signal processing apparatus of claim 3, wherein the predetermined reflected light amount threshold is increased in a stepwise manner.

5. An optical disc signal processing apparatus comprising:
a laser output circuit for irradiating an optical disc with laser to detect a reflected light amount, wherein the optical disc has a plurality of data recording layers and a ratio between reflectances of the plurality of data recording layers is constant;
a focus drive mechanism for moving the laser output circuit in a direction perpendicular to the optical disc to adjust a distance of a spot of the laser with respect to the optical disc;
a reflected light amount measuring circuit for measuring a plurality of reflected light amounts while using the focus drive mechanism to cause a spot position of the laser to move from a position away from the optical disc to a position at a predetermined distance or less from a disc surface;
a largest reflected light amount storing circuit for storing a first reflected light amount which is the largest of a plurality of reflected light amounts obtained in the reflected light amount measuring circuit, and a second reflected light amount which is the largest after the first reflected light amount; and
a reflected light amount comparing circuit for comparing the first reflected light amount with the second reflected light amount.

6. The optical disc signal processing apparatus of claim 5, further comprising:
a disc determining circuit for determining that the optical disc is a hybrid disc, based on the result of the comparison in the reflected light amount comparing circuit.

7. An optical disc signal reproducing apparatus employing the optical disc signal processing apparatus of claim 1, wherein
a reflected light amount reproduction threshold for determining a layer at which the focus drive mechanism is operated, is determined based on the first reflected light amount and the second reflected light amount,
a reflected light amount is measured while moving a spot position of the laser from a position close to the optical disc to a farther position, and the measured reflected light amount is compared with the reflected light amount reproduction threshold, and
the focus drive mechanism is operated from a spot position where a reflected light amount larger than or equal to the reflected light amount reproduction threshold is first obtained.

8. An optical disc signal reproducing apparatus employing the optical disc signal processing apparatus of claim 5, wherein
a reflected light amount reproduction threshold for determining a layer at which the focus drive mechanism is operated, is determined based on the first reflected light amount and the second reflected light amount,
a reflected light amount is measured while moving a spot position of the laser from a position close to the optical disc to a farther position, and the measured reflected light amount is compared with the reflected light amount reproduction threshold, and
the focus drive mechanism is operated from a spot position where a reflected light amount larger than or equal to the reflected light amount reproduction threshold is first obtained.

9. A signal processing circuit for controlling a laser output circuit for irradiating an optical disc with laser to detect a reflected light amount, wherein the optical disc has a plurality of data recording layers and a ratio between reflectances of the plurality of data recording layers is constant, and a focus drive mechanism for moving the laser output circuit in a direction perpendicular to the optical disc to adjust a distance of a spot of the laser with respect to the optical disc, the signal processing circuit comprising:
a drive control section for controlling a drive direction of the focus drive mechanism;
a reflected light amount receiving section for receiving the reflected light amount;
a first reflected light amount comparing circuit for comparing the reflected light amount with a predetermined reflected light amount threshold based on the drive direction;
a first reflected light amount storing circuit for storing a first reflected light amount which first becomes larger than or equal to the predetermined reflected light amount threshold in the first reflected light amount comparing circuit;
a second reflected light amount comparing circuit for comparing the reflected light amount with the predetermined reflected light amount threshold based on a direction opposite to the drive direction;
a second reflected light amount storing circuit for storing a second reflected light amount which first becomes larger than or equal to the predetermined reflected light amount threshold in the second reflected light amount comparing circuit; and
a reflected light amount comparing circuit for comparing the first reflected light amount with the second reflected light amount.

10. The signal processing circuit of claim 9, further comprising:
a disc determining circuit for determining that the optical disc is a hybrid disc, based on the result of the comparison in the reflected light amount comparing circuit.

11. The signal processing circuit of claim 9, further comprising:
a surface reflection determining circuit for determining whether or not the first or second reflected light amount is of surface reflection of the optical disc, based on the result of the comparison in the reflected light amount comparing circuit.

12. The signal processing circuit of claim 11, wherein the predetermined reflected light amount threshold is increased in a stepwise manner.

13. A signal processing circuit for controlling a laser output circuit for irradiating an optical disc with laser to detect a reflected light amount, wherein the optical disc has a plurality of data recording layers and a ratio between reflectances of the plurality of data recording layers is constant, and a focus drive mechanism for moving the laser output circuit in a direction perpendicular to the optical disc to adjust a distance of a spot of the laser with respect to the optical disc, the signal processing circuit comprising:
a drive control section for controlling a drive direction of the focus drive mechanism;
a reflected light amount receiving section for receiving the reflected light amount;
a reflected light amount storing circuit for storing a plurality of reflected light amounts received by the reflected light amount receiving section;
a largest reflected light amount storing circuit for storing a first reflected light amount which is the largest of the plurality of reflected light amounts stored in the reflected light amount storing circuit and a second reflected light amount which is the largest after the first reflected light amount; and
a reflected light amount comparing circuit for comparing the first reflected light amount with the second reflected light amount.

14. The signal processing circuit of claim 13, further comprising:
a disc determining circuit for determining that the optical disc is a hybrid disc, based on the result of the comparison in the reflected light amount comparing circuit.

15. A signal reproducing circuit employing the signal processing circuit of claim 9, wherein
a reflected light amount reproduction threshold for determining a layer at which the focus drive mechanism is operated, is determined based on the first reflected light amount and the second reflected light amount,
a reflected light amount is measured while moving a spot position of the laser from a position away from the optical disc to a closer position, and the measured reflected light amount is compared with the reflected light amount reproduction threshold, and
the focus drive mechanism is operated from a spot position where a reflected light amount larger than or equal to the reflected light amount reproduction threshold is first obtained.

16. A signal reproducing circuit employing the signal processing circuit of claim 13, wherein
a reflected light amount reproduction threshold for determining a layer at which the focus drive mechanism is operated, is determined based on the first reflected light amount and the second reflected light amount,
a reflected light amount is measured while moving a spot position of the laser from a position away from the optical disc to a closer position, and the measured reflected light amount is compared with the reflected light amount reproduction threshold, and
the focus drive mechanism is operated from a spot position where a reflected light amount larger than or equal to the reflected light amount reproduction threshold is first obtained.
